(19) United States
(12) Patent Application Publication
(10) Pub. No.: US 2026/0302374 A1
(43) Pub. Date: Oct. 1, 2026

(54) SECONDARY BATTERY

(71) Applicant: KABUSHIKI KAISHA TOSHIBA, Kawasaki-shi (JP)

(72) Inventor: Naoki IWAMURA, Kamakura Kanagawa (JP)

(73) Assignee: KABUSHIKI KAISHA TOSHIBA, Kawasaki-shi (JP)

(21) Appl. No.: 19/662,176

(22) Filed: Apr. 29, 2026

Related U.S. Application Data
(63) Continuation of application No. PCT/JP2025/019739, filed on May 30, 2025.

(30) Foreign Application Priority Data
Mar. 28, 2025 (JP) 2025-055925

(51) Int. Cl. H01M 10/0587; H01M 10/42; H01M 50/103; H01M 50/15

(52) U.S. Cl. CPC H01M 10/0587; H01M 10/4235; H01M 50/103; H01M 50/15

(57) ABSTRACT

According to one embodiment, a secondary battery includes an outer case including a bottom wall, a side wall, and an aperture portion, an electrode assembly including a pair of curved portions, a lid member, and an electrode-assembly retainer provided between the electrode assembly and the lid member. The electrode assembly is housed with one of top portions of the curved portions directed toward the aperture portion of the outer case. The electrode-assembly retainer includes at least one pair of protrusion portions protruding toward the curved portion. Distal end portions of the protrusion portion contact at least part of the curved portion across the top portion. A space portion including the top portion is provided between the distal end portions.

### CROSS-REFERENCE TO RELATED APPLICATIONS

This application is a Continuation Application of PCT Application No. PCT/JP2025/019739, filed May 30, 2025 and based upon and claiming the benefit of priority from prior Japanese Patent Application No. 2025-055925, filed Mar. 28, 2025, the entire contents of all of which are incorporated herein by reference.

### FIELD

Embodiments described herein relate generally to a secondary battery.

### BACKGROUND

In recent years, secondary batteries such as lead-acid batteries and nickel-metal hydride batteries have been used as power sources for electric vehicles, hybrid vehicles, electric motorcycles, forklifts, and the like. Recently, development aimed at adopting lithium-ion secondary batteries including high energy density has been actively conducted, while taking into consideration long service life and safety.

A general lithium-ion secondary battery (hereinafter referred to as a “secondary battery”) may house an electrode assembly including electrode members in an outer case including an aperture portion and may include a lid member at the aperture portion of the outer case. The outer case may include an electrode-assembly retainer between the electrode assembly and the lid member.

External impacts such as vibration may apply to the secondary battery and may displace the electrode assembly inside the secondary battery. Examples of the external impacts include vibration caused by traveling of a vehicle including the secondary battery. When the electrode-assembly retainer or the like does not sufficiently restrain the electrode assembly in the secondary battery, displacement of the electrode assembly may partially break the electrode assembly. Such partial breakage of the electrode assembly may increase resistance, decrease capacity, and further cause a short circuit or the like in the secondary battery.

### BRIEF DESCRIPTION OF THE DRAWINGS

FIG. 1 is a perspective view schematically showing a secondary battery of the first embodiment.

FIG. 2 is a perspective view schematically showing the secondary battery of the first embodiment in a state disassembled by component.

FIG. 3 is a perspective view schematically showing an electrode-assembly retainer used in the secondary battery according to the first embodiment.

FIG. 4 is a cross-sectional view of a periphery of the electrode-assembly retainer according to the first embodiment taken along the line I-I in FIG. 1 viewed in the arrow direction.

FIG. 5 is a perspective view schematically showing an electrode-assembly retainer used in the secondary battery according to the second embodiment.

FIG. 6 is a perspective view schematically showing a modified example of the electrode-assembly retainer used in the secondary battery according to the second embodiment.

FIG. 7 is a perspective view schematically showing an electrode-assembly retainer used in the secondary battery according to the third embodiment.

FIG. 8 is a cross-sectional view of a periphery of the electrode-assembly retainer according to the third embodiment taken along the line I-I in FIG. 1 viewed in the arrow direction.

### DETAILED DESCRIPTION

In general, according to one embodiment, a secondary battery includes an outer case including a bottom wall, a side wall, and an aperture portion, an electrode assembly formed by winding an electrode member, including a flat cross-sectional shape, and including a pair of curved portions, a lid member provided at the aperture portion of the outer case, and an electrode-assembly retainer provided between the electrode assembly and the lid member. The electrode assembly is housed with one of top portions of the curved portions directed toward the aperture portion of the outer case. The electrode-assembly retainer includes at least one pair of protrusion portions protruding toward the curved portion. Distal end portions of the protrusion portion contact at least part of the curved portion across the top portion. A space portion including the top portion is provided between the distal end portions.

The following describes a secondary battery 1 of embodiments with reference to figures.

### First Embodiment

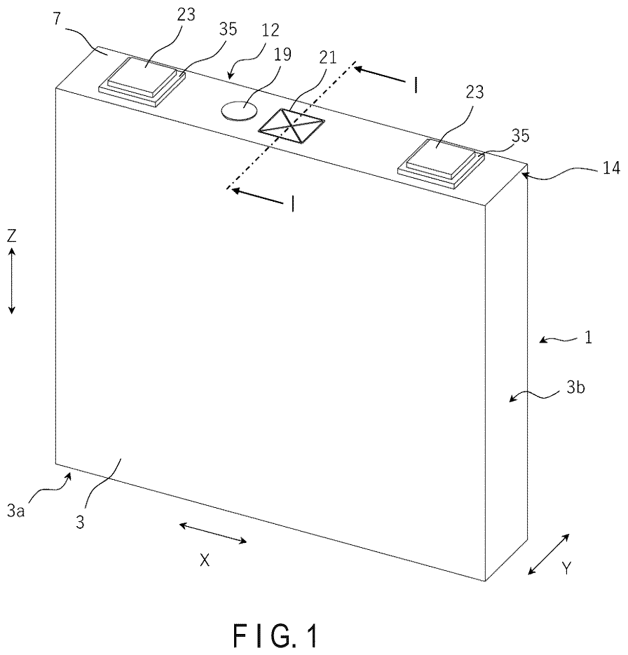

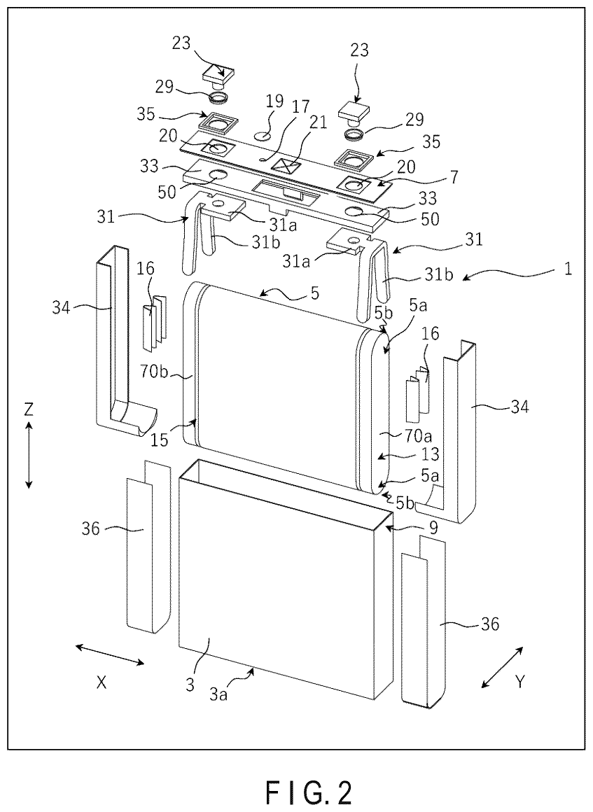

The following describes the secondary battery 1 of the first embodiment with reference to FIG. 1 and FIG. 2. FIG. 1 is a perspective view schematically showing a secondary battery 1 of the first embodiment. FIG. 2 is a perspective view schematically showing the secondary battery 1 of the first embodiment in a state disassembled by component.

As shown in FIG. 1 and FIG. 2, the secondary battery 1 includes an outer case 3 and an electrode assembly 5 housed in the outer case 3. For example, the outer case 3 has a tubular shape including a bottom wall 3a and a side wall 3b. An aperture portion 9 is provided in the outer case 3. For example, a lid member 7 including a first through hole 20 is provided at the aperture portion 9. The outer case 3 and the lid member 7 are formed of a metal such as aluminum, an aluminum alloy, iron, copper, or stainless steel. For example, the lid member 7 has a rectangular shape including a long side 12 and a short side 14.

The electrode assembly 5 is produced, for example, by winding an electrode member (not illustrated) including a positive electrode 13 and a negative electrode 15 around an axis and then press-forming the entire wound body into a flat cross-sectional shape. The electrode assembly 5 includes a pair of curved portions 5a. The pair of curved portions 5a each has an top portion 5b. The electrode assembly 5 is housed such that one of the top portions 5b faces the aperture portion 9 of the outer case 3 and the other top portion 5b faces the bottom wall 3a of the outer case 3.

The positive electrode 13 includes a positive current collector (not shown) and a positive active material supporter portion (not shown) supported on the positive current collector. The positive current collector includes a positive current collector tab 70a as a part where the positive active material supporter portion is not coated. In contrast, the negative electrode 15 includes a negative current collector (not shown) and a negative active material supporter portion (not shown) supported on the negative current collector. The negative current collector includes a negative current collector tab 70b as a part where the negative active material supporter portion is not coated. The positive current collector tab 70a and the negative current collector tab 70b are sometimes collectively referred to as current collector tabs 70.

In the present embodiment, the electrode assembly 5 is a wound body. A plurality of layers of the current collector tabs 70 are provided at least one end of the electrode assembly 5 to extend out from the positive electrode 13 and the negative electrode 15. In the present embodiment, the positive electrode current collector tab 70a extends out in a direction opposite to an extension direction of the negative electrode current collector tab 70b. The current collector tabs 70 are provided at both ends of the electrode assembly 5 in a winding axis direction and extend out in a direction orthogonal to a housing direction (Z direction) of the electrode assembly 5 into the outer case 3. The extension directions of the positive current collector tab 70a and the negative current collector tab 70b are not limited to these directions. For example, both of the current collector tabs 70 may extend in the same direction and may be provided at one end of the electrode assembly 5.

When the electrode assembly 5 including the wound structure is used and the current collector tabs 70 are provided at both ends in the direction of the winding axis as in the present embodiment, the distal end of the current collector tab 70 is preferably clamped by two or more metal members 16. Here, clamping signifies that the metal member 16 bundles and integrates the plurality of current collector tabs 70. At least part of the metal member 16 may contact one face and the other face of the current collector tab 70. This configuration can achieve stable clamping of the current collector tabs 70 by the metal members 16, for example, when the weight of the electrode assembly 5 is increased as a means to increase the capacity of the secondary battery 1. Here, increasing the weight of the electrode assembly 5 includes enlarging the dimensions of the electrode assembly 5 or increasing the number of windings of the electrodes to increase the mass of the electrode active material in the electrode assembly 5. The number of the metal members 16 provided for each of the current collector tabs 70 at the respective ends of the electrode assembly 5 is not limited to these examples. At least one of the current collector tabs 70 at the respective ends of the electrode assembly 5 is preferably clamped by one or more metal members 16.

In the secondary battery 1 of the present embodiment, an electrode-assembly retainer 33 made of an insulating member is provided between the electrode assembly 5 and the lid member 7. A pair of electrode-assembly retainers 33 may be respectively provided at the positive electrode 13 side and the negative electrode 15 side. Alternatively, one electrode-assembly retainer 33 is provided integrally for the two sides. In the secondary battery 1 in FIG. 2, the electrode-assembly retainer 33 is provided integrally on the positive electrode 13 side and the negative electrode 15 side.

The electrode-assembly retainer 33 may include a second through hole 50. In that case, the first through hole 20 of the lid member 7 and the second through hole 50 of the electrode-assembly retainer 33 preferably align with each other in the housing direction (Z direction) of the electrode assembly 5 into the outer case 3. A terminal 23 is provided in the first through hole 20 of the lid member 7 and the second through hole 50 of the electrode-assembly retainer 33. The terminal 23 is made of a conductive material such as a metal. The terminal 23 closely contacts the lid member 7 via an insulating gasket 29.

The terminal 23 may be further connected to a conductive member 31. Here, the conductive member 31 includes a first substrate portion 31a provided between the electrode assembly 5 and the electrode-assembly retainer 33, and a second substrate portion 31b provided between the electrode assembly 5 and the side wall 3b of the outer case 3 and connected to the first substrate portion 31a. The conductive member 31 in the present embodiment includes two second substrate portions 31b for one first substrate portion 31a. The number of the second substrate portions 31b is not limited to this example.

Preferably, the electrode assembly 5 is electrically connected to the terminal 23 by joining the conductive member 31 to the metal member 16 clamping the current collector tab 70. Joining the conductive member 31 to the metal member 16 can prevent tearing of the current collector tab 70 at the time of joining than directly joining the conductive member 31 to the current collector tab 70.

In the secondary battery 1 of the present embodiment, the lid member 7 includes an injection port 17 together with a gas vent valve 21. The injection port 17 may be omitted from the lid member 7.

In the present embodiment, an insulating cover 34 provided between the current collector tab 70 and the outer case 3 electrically insulates the current collector tab 70 from the outer case 3. The insulating cover 34 may be fixed to the electrode assembly 5 by an insulating tape 36. A terminal insulator 35 may be provided between the terminal 23 and the lid member 7. The terminal insulator 35 electrically insulates the terminal 23 and the lid member 7.

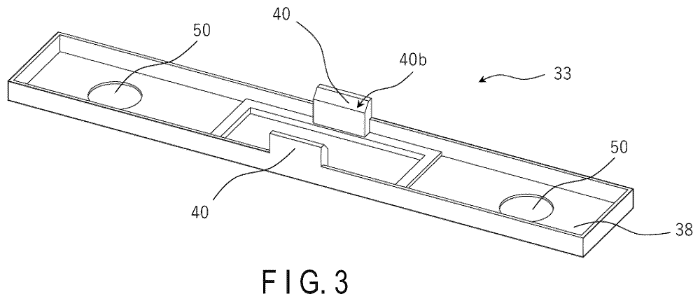

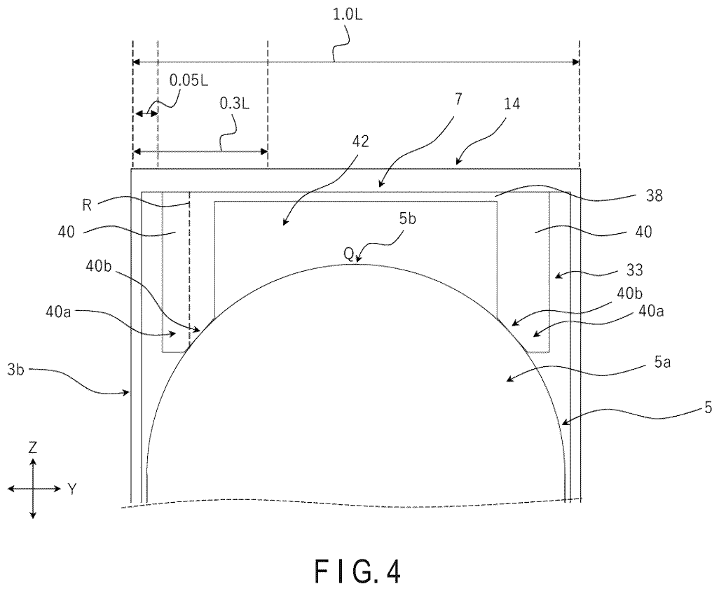

The following describes the electrode-assembly retainer 33 used in the secondary battery 1 of the present embodiment with reference to FIG. 3 and FIG. 4. FIG. 3 is a perspective view schematically showing the electrode-assembly retainer 33 used in the secondary battery 1 of the first embodiment. FIG. 4 is a cross-sectional view of a periphery of the electrode-assembly retainer 33 taken along the line I-I in FIG. 1 viewed in the arrow direction.

As shown in FIG. 3 and FIG. 4, the electrode-assembly retainer 33 includes a substrate portion 38 facing the lid member 7 and includes at least one pair of protrusion portions 40 protruding toward the curved portion 5a of the electrode assembly 5. The electrode-assembly retainer 33 of the first embodiment includes one pair of the protrusion portions 40. A distal end portion 40a of the protrusion 40 contacts at least part of the curved portion 5a of the electrode assembly 5. Further, as shown in FIG. 4, a space portion 42 including the top portion 5b of the electrode assembly 5 is provided between the distal end portions 40a of the protrusion portions 40.

In the secondary battery 1 of the present embodiment, the electrode-assembly retainer 33 includes the pair of protrusions 40. The distal end portion 40a of the protrusion 40 contacts at least part of the curved portion 5a of the electrode assembly 5. This contact between the protrusion portions 40 and the electrode assembly 5 restrains the electrode assembly 5 in the height direction (Z direction) of the secondary battery 1. Even when the electrode assembly 5 displaces in the height direction (Z direction) of the electrode assembly 5, the protrusion portion 40 presses the electrode assembly 5 in the same direction (Z direction) as the displacement direction. This configuration sufficiently prevents displacement of the electrode assembly 5 in the Z direction. Thus, even when an external impact such as vibration is applied to the secondary battery 1, the electrode-assembly retainer 33 including the pair of the protrusion portions 40 prevents displacement of the electrode assembly 5. Thus, the present embodiment can provide the secondary battery 1 including excellent vibration resistance. Thus, the secondary battery 1 of the present embodiment can prevent breakage of part of the electrode assembly 5 due to displacement of the electrode assembly 5, and can prevent an increase in resistance, a decrease in capacity, and further a short circuit or the like in the secondary battery 1 due to breakage of the electrode assembly 5.

Further, the present embodiment has the space portion 42 including the top portion 5b of the electrode assembly 5 provided between the distal end portions 40a of the protrusions 40. This configuration enables the space portion 42 to secure a movement path of gas to the gas vent valve 21 even when excessive gas generation occurs in the electrode assembly 5 in the secondary battery 1. Thus, the present embodiment can provide the secondary battery 1 with ensured safety.

As described above, the secondary battery 1 of the present embodiment may include the insulating cover 34 in the width direction (X direction) of the secondary battery 1. In that case, the insulating cover 34 restrains the electrode assembly 5 in the X direction. The configuration in which the protrusion portion 40 of the electrode-assembly retainer 33 restrains the electrode assembly 5 in the height direction (Z direction) of the secondary battery 1 in the present embodiment sufficiently restrains the electrode assembly 5 in both the width direction (X direction) and the height direction (Z direction) of the secondary battery 1. Thus, even when an external impact such as vibration is applied to the secondary battery 1, the present embodiment enables the electrode-assembly retainer 33 and the insulating cover 34 to prevent displacement of the electrode assembly 5. Thus, the present embodiment can provide the secondary battery 1 including excellent vibration resistance.

The following further describes the electrode-assembly retainer 33 of the present embodiment. The distal end portion 40a of the protrusion 40 of the electrode-assembly retainer 33 contacts at least part of the curved portion 5a of the electrode assembly 5. The distal end portion 40a preferably has a chamfered portion 40b along an outer surface of the curved portion 5a. The chamfered portion 40b can sufficiently secure a contact area between the chamfered portion 40b and the electrode assembly 5 and can sufficiently restrain the electrode assembly 5.

As described above, to secure a movement path of gas to the gas vent valve 21 when excessive gas generation occurs in the electrode assembly 5 in the secondary battery 1, the substrate portion 38 of the electrode-assembly retainer 33 preferably is not provided at a position overlapping the gas vent valve 21 in the housing direction (Z direction) of the electrode assembly 5. Specifically, part of the substrate portion 38 is notched at a position overlapping the gas vent valve 21 in the Z direction in the electrode-assembly retainer 33 of the present embodiment. This configuration can appropriately secure a movement path of gas to the gas vent valve 21.

Further, as shown in FIG. 4, the protrusion portion 40 of the electrode-assembly retainer 33 is preferably provided to be parallel to the side wall 3b of the outer case 3. Here, “parallel to the side wall 3b of the outer case 3” signifies that “parallel to the housing direction (Z direction) of the electrode assembly 5.” as well. As described above, the protrusion portions 40 of the electrode-assembly retainer 33 restrain the electrode assembly 5 in the height direction (Z direction) of the electrode assembly 5. This configuration sufficiently prevents displacement of the electrode assembly 5 in the Z direction even when the electrode assembly 5 displaces in the height direction (Z direction) of the electrode assembly 5.

The following describes a specific position where the protrusion portions 40 are provided with reference to FIG. 4. When the lid member 7 has a rectangular shape including the long side 12 and the short side 14, one of the protrusion portions 40 is provided in an area of 0.05 L or more and 0.3 L or less from one end of the lid member 7 toward the other end with respect to a length 1.0 L of the short side 14. Here, a center R in the thickness direction (Z direction) in the short-side-14 direction of the secondary battery 1 in the protrusion portion 40 needs to be located in the area of 0.05 L or more and 0.3 L or less. The other protrusion portion 40 is provided line-symmetrically to the one protrusion portion 40 with respect to a line Q passing through the top portion 5b of the electrode assembly 5 and parallel to the long side 12 of the lid member 7.

Providing the one protrusion portion 40 in the area of 0.05 L or more enables the protrusion portion 40 to appropriately contact the curved portion 5a of the electrode assembly 5 while keeping sufficient strength of the protrusion portion 40. If one of the protrusion portion 40 is provided in an area of less than 0.05 L, the distance in the Z direction between the substrate portion 38 of the electrode-assembly retainer 33 and the curved portion 5a of the electrode assembly 5 increases. This requires increasing a length of the protrusion portion 40 in the Z direction and may cause insufficient strength of the protrusion portion 40. Providing the one protrusion portion 40 in the area of 0.3 L or less enables the space portion 42 including the top portion 5b to be sufficiently provided and enables the sufficient space portion 42 to secure a movement path of gas to the gas vent valve 21.

The following describes the position of the protrusion portion 40 of the electrode-assembly retainer 33. As described above, for providing the terminal 23, the first through hole 20 of the lid member 7 and the second through hole 50 of the electrode-assembly retainer 33 preferably align with each other in the Z direction. The protrusion portion 40 of the electrode-assembly retainer 33 preferably is provided closer to the center portion of the lid member 7 than the first through hole 20 of the lid member 7. When the terminal 23 is further connected to the conductive member 31 as described above, the first substrate portion 31a of the conductive member 31 overlaps the electrode-assembly retainer 33, which leaves no space for providing the protrusion portions 40 at a position where the terminal 23 is provided. On the center side relative to the position where the terminal 23 is provided, the substrate portion 38 of the electrode-assembly retainer 33 faces the electrode assembly 5 and leaves space for providing the protrusion portions 40. This configuration enables providing the protrusion portions 40 at the position contacting the electrode assembly 5.

In the present embodiment, the electrode-assembly retainer 33 includes the pair of the protrusion portions 40. In that case, as shown in FIG. 3, the pair of the protrusion portions 40 preferably are provided at the center portion of the electrode-assembly retainer 33. This configuration enables the protrusion portions 40 to contact the center portion of the electrode assembly 5 and enables the protrusion portions 40 to uniformly restrain the entire electrode assembly 5.

In the secondary battery 1 of the first embodiment described above, the electrode-assembly retainer 33 includes the pair of the protrusion portions 40 protruding toward the curved portion 5a of the electrode assembly 5. The distal end portion 40a of the protrusion 40 contacts at least part of the curved portion 5a of the electrode assembly 5. This contact between the protrusion portions 40 and the electrode assembly 5 restrains the electrode assembly 5 in the height direction (Z direction) of the secondary battery 1. This configuration sufficiently prevents displacement of the electrode assembly 5 in the Z direction even when the electrode assembly 5 displaces in the height direction (Z direction) of the electrode assembly 5. Thus, even when an external impact such as vibration is applied to the secondary battery 1, the electrode-assembly retainer 33 including the pair of the protrusion portions 40 prevents displacement of the electrode assembly 5. Thus, the present embodiment can provide the secondary battery 1 including excellent vibration resistance. Thus, the secondary battery 1 of the present embodiment can prevent breakage of part of the electrode assembly 5 due to displacement of the electrode assembly 5, and can prevent an increase in resistance, a decrease in capacity, and further a short circuit or the like in the secondary battery 1 due to breakage of the electrode assembly 5.

Further, the present embodiment has the space portion 42 including the top portion 5b of the electrode assembly 5 provided between the distal end portions 40a of the protrusions 40. This configuration enables the space portion 42 to secure a movement path of gas to the gas vent valve 21 even when excessive gas generation occurs in the electrode assembly 5 in the secondary battery 1. Thus, the present embodiment can provide the secondary battery 1 with ensured safety.

### Second Embodiment

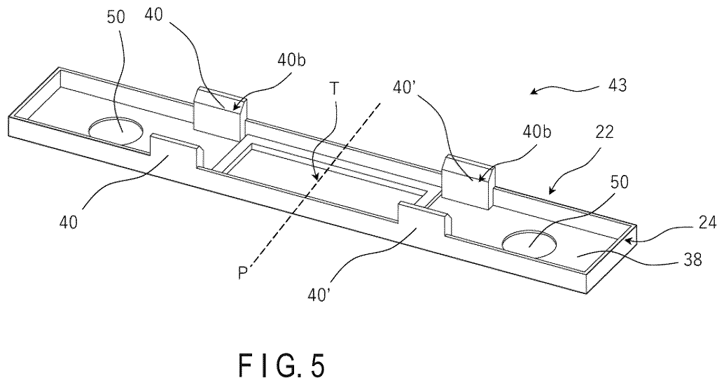

The following describes a modified example 1 (an electrode-assembly retainer 43) of the electrode-assembly retainer 33 used in the secondary battery 1 of the second embodiment with reference to FIG. 5. FIG. 5 is a perspective view schematically showing the electrode-assembly retainer 43 used in the secondary battery 1 of the second embodiment. The electrode-assembly retainer 43 of the second embodiment differs from the electrode-assembly retainer 33 of the first embodiment in that the electrode-assembly retainer 43 has two pairs of the protrusion portion 40 and the position at which the protrusion portion 40 is provided.

The following describes the position of the protrusion portion 40 of the electrode-assembly retainer 43. When the electrode-assembly retainer 43 has a rectangular shape including a long side 22 and a short side 24, the first pair of the protrusion portions 40 is provided line-symmetrically to a second pair of the protrusion portions 40′ with respect to a line P passing through a center point T of the electrode-assembly retainer 43 and parallel to the short side 24 of the electrode-assembly retainer 43. Providing the first pair of the protrusion portions 40 and the second pair of the protrusion portions 40′ line-symmetrically with respect to the line P is preferable from the viewpoint of moldability and strength of the electrode-assembly retainer 33.

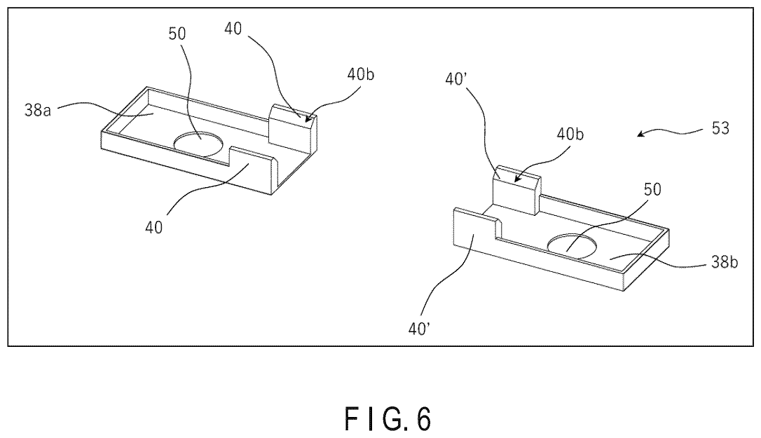

As shown in FIG. 6, the electrode-assembly retainer 43 of the present embodiment may be provided as a pair separated into the positive electrode 13 side and the negative electrode 15 side. FIG. 6 is a perspective view schematically showing a modification example 2 (an electrode-assembly retainer 53) of the electrode-assembly retainer 43 used in the secondary battery 1 of the second embodiment. As described above, to secure a movement path of gas to the gas vent valve 21 when excessive gas generation occurs in the electrode assembly 5 in the secondary battery 1, the substrate portion 38 preferably is not provided at a position overlapping the gas vent valve 21 in the housing direction (Z direction) of the electrode assembly 5. The substrate portion 38 of the electrode-assembly retainer 33 may be provided in the area of 60% or less with respect to the area of the gas vent valve 21. In the present embodiment, the electrode-assembly retainer 53 is not provided at the position overlapping the gas vent valve 21 in the Z direction. Instead, the electrode-assembly retainer 53 is provided as the pair separated into the positive electrode 13 side and the negative electrode 15 side. This configuration can appropriately secure a movement path of gas to the gas vent valve 21. More specifically, the pair of the protrusion portions 40 is connected to a first substrate portion 38a. The second pair (the protrusion portions 40′) is connected to a second substrate portion 38b. The first substrate portion 38a and the second substrate portion 38b face the lid member 7.

In the secondary battery 1 of the second embodiment, the electrode-assembly retainer 43 includes the two pairs of the protrusion portions 40 protruding toward the curved portions 5a of the electrode assemblies 5. The distal end portion 40a of the protrusion 40 contacts at least part of the curved portion 5a of the electrode assembly 5. This configuration can restrain the electrode assembly 5 in the height direction (Z direction) of the secondary battery 1. Providing two pairs of the protrusion portions 40 can increase the contact area of the electrode assembly 5 and the protrusion portions 40. Thus, the configuration can sufficiently restrain the electrode assembly 5 compared to the case where the pair of the protrusion portions 40 is provided. Thus, even when the electrode assembly 5 displaces in the height direction (Z direction) of the electrode assembly 5, the protrusion portion 40 presses the electrode assembly 5 in the same direction (Z direction) as the displacement direction. This configuration sufficiently prevents displacement of the electrode assembly 5 in the Z direction. Thus, even when an external impact such as vibration is applied to the secondary battery 1, the electrode-assembly retainer 33 including one pair of the protrusion portions 40 prevents displacement of the electrode assembly 5. Thus, the present embodiment can provide the secondary battery 1 with excellent vibration resistance. Thus, the secondary battery 1 of the present embodiment can prevent breakage of part of the electrode assembly 5 due to displacement of the electrode assembly 5, and can prevent an increase in resistance, a decrease in capacity, and further a short circuit or the like in the secondary battery 1 due to breakage of the electrode assembly 5.

### Third Embodiment

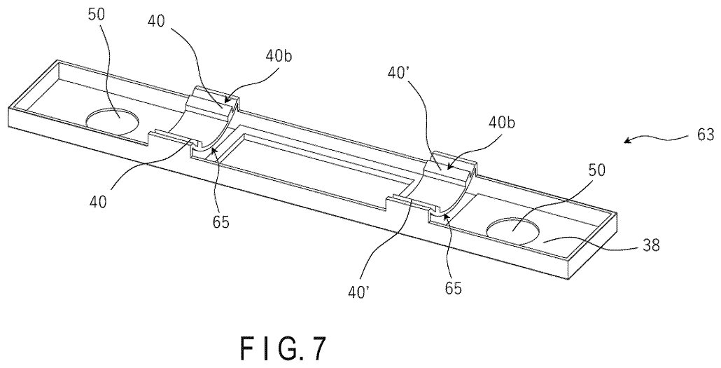

The following describes a modified example 3 (an electrode-assembly retainer 63) of the electrode-assembly retainer 33 used in the secondary battery 1 of the third embodiment with reference to FIG. 7. FIG. 7 is a perspective view schematically showing the electrode-assembly retainer 63 used in the secondary battery 1 of the third embodiment. As shown in FIG. 7, the electrode-assembly retainer 63 of the third embodiment differs from the electrode-assembly retainer 33 of the first embodiment and the electrode-assembly retainer 43 of the second embodiment in that the electrode-assembly retainer 63 includes a proximity plate portion 65. FIG. 7 shows the electrode-assembly retainer 63 including two pairs of the protrusion portions 40. At least one pair of the protrusion portions 40 is provided. Alternatively, one pair or three pairs of the protrusion portion 40 may be provided.

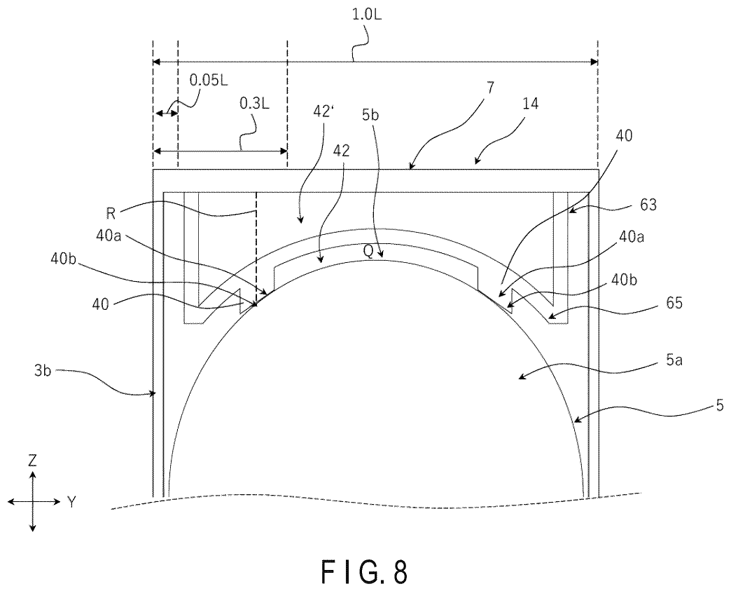

The following describes the proximity plate portion 65 of the electrode-assembly retainer 63 with reference to FIG. 8. FIG. 8 is a cross-sectional view of a periphery of the electrode-assembly retainer 63 of the third embodiment taken along the line I-I in FIG. 1 viewed in the arrow direction. As shown in FIG. 8, the proximity plate portion 65 is provided along the outer surface of the curved portion 5a of the electrode assembly 5. The protrusion portion 40 protrudes with respect to the proximity plate portion 65 and contacts the electrode assembly 5.

In the secondary battery 1 of the third embodiment, the electrode-assembly retainer 63 includes the proximity plate portion 65, and a distance in the Z direction between the proximity plate portion 65 and the curved portion 5a of the electrode assembly 5 is short. Thus, the third embodiment can minimize the volume of the protrusion portion 40. Minimizing the volume of the protrusion portion 40 in the outer case 3 can increase the volume of the electrode assembly 5 in the outer case 3. This configuration enables an increase in mass of an electrode active material in the electrode assembly 5, such as increasing dimensions of the electrode assembly 5 or increasing the number of windings of the electrode, thereby increasing capacity of the electrode assembly 5. Thus, the present embodiment can provide the secondary battery 1 including excellent vibration resistance and high capacity, by restraining the electrode assembly 5 in the height direction (Z direction) of the secondary battery 1 by the protrusion portions 40 while minimizing the volume of the protrusion portions 40.

Further, the present embodiment has the space portion 42 including the top portion 5b of the electrode assembly 5 provided between the distal end portions 40a of the protrusions 40. Furthermore, a space portion 42′ is provided between the proximity plate portion 65 and the substrate portion 38 as well. This configuration enables the space portions 42 and 42′ both to secure a movement path of gas to the gas vent valve 21 even when excessive gas generation occurs in the electrode assembly 5 in the secondary battery 1. Thus, the present embodiment can provide the secondary battery 1 with ensured safety.

In the secondary battery 1 of at least one of the embodiments described above, the electrode-assembly retainer 33 includes the pair of the protrusion portions 40 protruding toward the curved portions 5a of the electrode assembly 5. The distal end portion 40a of the protrusion 40 contacts at least part of the curved portion 5a of the electrode assembly 5. This contact between the protrusion portion 40 and the electrode assembly 5 restrains the electrode assembly 5 in the height direction (Z direction) of the secondary battery 1. Even when the electrode assembly 5 displaces in the height direction (Z direction) of the electrode assembly 5, the protrusion portion 40 presses the electrode assembly 5 in the same direction (Z direction) as the displacement direction. This configuration sufficiently prevents displacement of the electrode assembly 5 in the Z direction. Thus, even when an external impact such as vibration is applied to the secondary battery 1, the electrode-assembly retainer 33 including the pair of the protrusion portions 40 prevents displacement of the electrode assembly 5. Thus, the present embodiment can provide the secondary battery 1 including excellent vibration resistance. Thus, the secondary battery 1 of the present embodiment can prevent breakage of part of the electrode assembly 5 due to displacement of the electrode assembly 5, and can prevent an increase in resistance, a decrease in capacity, and further a short circuit or the like in the secondary battery 1 due to breakage of the electrode assembly 5.

Further, the present embodiment has the space portion 42 including the top portion 5b of the electrode assembly 5 provided between the distal end portions 40a of the protrusions 40. This configuration enables the space portion 42 to secure a movement path of gas to the gas vent valve 21 even when excessive gas generation occurs in the electrode assembly 5 in the secondary battery 1. Thus, the present embodiment can provide the secondary battery 1 with ensured safety.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. These embodiments and variations thereof are included in the scope and gist of the invention as well as in the claims and their equivalents.

What is claimed is

1. A secondary battery, comprising:
an outer case including a bottom wall, a side wall, and an aperture portion;
an electrode assembly formed by winding an electrode member, including a flat cross-sectional shape, and including a pair of curved portions;
a lid member provided at the aperture portion of the outer case; and
an electrode-assembly retainer provided between the electrode assembly and the lid member, wherein
the electrode assembly is housed with one of top portions of the curved portions directed toward the aperture portion of the outer case, the electrode-assembly retainer includes at least one pair of protrusion portions protruding toward the curved portion,
distal end portions of the protrusion portion contact at least part of the curved portion across the top portion, and
a space portion including the top portion is provided between the distal end portions.

2. The secondary battery of claim 1, wherein
the protrusion portion is parallel to the side wall.

3. The secondary battery of claim 1, wherein
the lid member has a rectangular shape including a long side and a short side,
one of the protrusion portions is provided in an area of 0.05 L or more and 0.3 L or less from one end of the lid member toward the other end with respect to a length 1.0 L of the short side, and
the other of the protrusion portions is provided line-symmetrically with respect to a line passing through the top portion and parallel to the long side.

4. The secondary battery of claim 1, wherein
the lid member includes a through hole in which a terminal is provided, and
the protrusion portion is provided closer to a center portion of the lid member than the through hole.

5. The secondary battery of claim 1, wherein
the electrode-assembly retainer has a rectangular shape including a long side and a short side and includes two pairs of the protrusion portions, and
the two pairs of the protrusion portions are provided line-symmetrically with respect to a line passing through a center point of the electrode-assembly retainer and parallel to the short side.

6. The secondary battery of claim 5, wherein
the electrode-assembly retainer includes:
a first substrate portion connected to one pair of the two pairs of the protrusion portions, and
a second substrate portion connected to the other pair of the two pairs of the protrusion portions, and
the first substrate portion and the second substrate portion face the lid member.

7. The secondary battery of claim 1, wherein
the electrode-assembly retainer includes a proximity plate portion provided along an outer surface of the curved portion, and
the protrusion portion protrudes with respect to the proximity plate portion.
